(19) United States
(12) Patent Application Publication
(10) Pub. No.: US 2016/0221838 A1
(43) Pub. Date: Aug. 4, 2016

(54) SELENIUM REMOVAL

(71) Applicant: JOHNSON MATTHEY PUBLIC LIMITED COMPANY, London (GB)

(72) Inventors: Stephen William COLLEY, Middlesbrough, Cleveland (GB); Pasi Markus KAUPPINEN, Salo (FI); Matthew Alexander LINCOLN, Redcar, Cleveland (GB); Javier TORROBA, Eaglescliffe, Cleveland (GB)

(21) Appl. No.: 15/021,416

(22) PCT Filed: Sep. 12, 2014
(86) PCT No.: PCT/GB2014/052765

§ 371 Date: Mar. 11, 2016

(30) Foreign Application Priority Data
Sep. 12, 2013 (GB) 1316246.6

(51) Int. Cl. C02F 1/28; B01J 20/22

(52) U.S. Cl. CPC C02F 1/288; C02F 1/285; B01J 20/22; C02F 2103/365

(57) ABSTRACT

Method, apparatus and adsorbents for the removal of selenium from feeds such as waste water streams from refineries and power plants.

### FIELD OF THE INVENTION

The present invention relates to removal of selenium from feeds such as waste water streams from refineries and power plants. In particular, the present invention provides adsorbents, uses of those adsorbents, and methods of removing selenium.

### BACKGROUND OF THE INVENTION

Selenium is present in the environment in both inorganic and organic forms, and in solid, liquid and gas phases. It can exist in five oxidation states (II⁻, 0, II⁺, IV⁺, VI⁺), but the II⁺ state is not known to exist in nature (Reference 1). The four most common, naturally occurring oxidation states are:

Se(-II): found for example as H₂Se, HSe⁻, metal selenides, alkyl selenides, seleno-amino acids and selenoproteins;
Se(0): found for example as trigonal (grey) and monoclinic (red) crystalline forms;
Se(IV): found for example as SeO₃²⁻, HSeO³⁻ and H₂SeO₃; and
Se(VI): found for example SeO₄²⁻ and HSeO₄⁻.

Selenium is present in a number of waste water streams, for example in waste water produced in refineries and power plants. Selenium contamination in the environment is problematic. Although selenium is an essential element for animal nutrition, it can have an adverse effect when present at higher concentrations. As a result, in some countries there are stringent regulations relating to the selenium content of waste water, and accordingly reliable removal technologies are required.

However, there are a number of technical challenges associated with the removal of selenium from water. Typically, selenium is present at low concentrations compared to other species present in the water, and so it can be difficult to selectively remove selenium species. This is particularly problematic in the context of waste water e.g. from refineries and power plants, where there is a large volume of effluent to be treated making many possible removal methods prohibitively expensive.

Selenium chemistry also poses difficulties for its effective removal. As outlined above, selenium exists in many soluble and particulate forms, and treatment technologies typically are not equally effective for different selenium species which may be present in waste water.

Furthermore, even within a single facility the selenium speciation may not be consistent; it could vary as water passes through the facility, or vary from day to day as a result of a range of factors.

A further difficulty arises since selenium has similar chemical properties to sulphur, meaning that its removal in the presence of sulphur can be particularly challenging. For example, if sulphur is present in higher concentrations than selenium in the water to be treated, it may be removed in preference to selenium thereby reducing the efficacy of the selenium removal technology employed.

Several technologies have been explored to treat selenium-containing wastewaters to meet stringent regulations. The treatment technologies can be grouped broadly in three main categories: physical, chemical and biological treatments. Physical treatments include reverse osmosis, membrane filtration, ion exchange and evaporation. Chemical treatments include reduction, precipitation, adsorption and coagulation. Biological treatments include biological volatilization (by plants, algae and microbes), microbial reduction (passive or active treatments) and wetlands.

Adsorption of selenium has been of particular interest in the field. Parida et al (Reference 2) have investigated the adsorption of Se(IV) onto various ferric oxyhydroxide surfaces. They found that amorphous ferrihydrite adsorbed significantly more Se(IV) than the other phases. Adsorption was strongly dependent on solution pH. Adsorption fell rapidly as the pH was increased from 3.5 to 9.5. There was essentially no adsorption at pH 9.5.

Hydrotalcite like materials have also been tested for the removal of selenium species, since these materials have high anion exchange capacity (References 3, 4, 5 and 6). The adsorption was found to depend on the hydrotalcite nature and on the pH. Competing anions were found to strongly affect the adsorption behaviour of SeO₃²⁻.

Western States Petroleum Association have investigated the use of strong base anion resins for selenium removal from refinery waste waters (Reference 7). They found that such resins were inefficient for selenium removal because sulphate displaced selenium, resulting in selenium breakthrough.

Ramana et al (Reference 8) investigated the use of chelating polymers for selenium removal in the presence of sulphate. Resins Dow 2N and IRA-900 were investigated at pH 9.5. Dow 2N has a macroporous polystyrene matrix and a nitrogen-containing functional group. Ramana et al describe selective uptake of Se(IV) and As(V) by this resin.

JP2001113272 describes a chelate fibre for removal of Se(IV), Se(VI), As(III) or As(V) from aqueous solution. The pH of the solution is adjusted to 0-6.

### SUMMARY OF THE INVENTION

There remains a need for improved selenium removal technologies, in particular those which are effective to reduce selenium concentrations to very low levels, and/or which are effective for removing more than one species of selenium. There also remains a need for selenium removal technologies which are effective in the presence of other substances, particularly sulphur.

Waste water feeds, e.g. from refineries, are often alkaline. It would be advantageous to be able to remove selenium species, especially selenide species from such feeds without the need for adjustment of the pH. Accordingly, there also remains a need for selenium removal technologies which are suitable for selective removal of selenium across a range of pHs, particularly at neutral or alkaline pH.

As demonstrated in Example 7 below, the present inventors have found that adsorption of selenium species can be improved by providing two or more different functional groups for selenium adsorption. Accordingly, in a first preferred aspect the present invention provides use of an adsorbent for adsorption of one or more selenium species, wherein the adsorbent comprises a support having functional groups capable of adsorbing selenium species immobilised thereon, wherein at least two different functional groups capable of adsorbing selenium species are provided.

This could be achieved, for example, by providing a mixture of two or more different adsorbents, each adsorbent having different functional groups immobilised thereon. In light of the teaching provided herein, the skilled person will readily appreciate that preferably the functional groups are predominantly located on the outer surface of the support.

In a second preferred aspect, the present invention provides a method for the purification of water by the removal of one or more selenium species from the water, the method comprising contacting the water with an adsorbent, wherein the adsorbent comprises a support having functional groups capable of adsorbing selenium species immobilised thereon, wherein at least two different functional groups capable of adsorbing selenium species are provided.

In a third preferred aspect, the present invention provides selenium removal apparatus for removing one or more selenium species from a fluid, the apparatus comprising a bed of adsorbent and means for contacting the fluid with the bed of adsorbent, wherein the adsorbent comprises a support having functional groups capable of adsorbing selenium species immobilised thereon, wherein at least two different functional groups capable of adsorbing selenium species are provided. Typically, the apparatus will include means for flowing the fluid to be treated past the bed of adsorbent.

The present inventors have additionally found that where functionalised adsorbents or ion exchange materials are employed for selenium removal, the location of the functional group is important in improving the performance of these materials. In particular, the present inventors have found that it is preferable to locate selenium adsorbing functional groups primarily at the outer surface of adsorbent particles, rather than distributing those functional groups throughout the pore volume, if any. Without wishing to be bound by theory, the present inventors consider that this may be due to improved (faster) adsorption kinetics which are observed in the examples. The effect of location of functional groups is demonstrated in the Examples, in particular in Examples 3 and 4. Accordingly, it is preferable that the functional groups capable of adsorbing selenium species are predominantly located on the outer surface of the support.

Typically, the selenium is removed from a fluid, preferably water (e.g. an aqueous solution comprising selenium species). For example, the selenium may be removed from waste water, e.g. waste water from an industrial process. The present inventors consider that the present invention is particularly applicable to removal of selenium species from waste water from refineries (e.g. petroleum refineries), coal and oil fired power plants, ground water and mine tailings.

In a further preferred aspect the present invention provides use of an adsorbent for adsorption of one or more selenium species, wherein the adsorbent comprises a support having functional groups capable of adsorbing selenium species immobilised thereon, wherein said functional groups are predominantly located on the outer surface of the support.

In a further preferred aspect, the present invention provides a method for the purification of water by the removal of one or more selenium species from the water, the method comprising contacting the water with an adsorbent, wherein the adsorbent comprises a support having functional groups capable of adsorbing selenium species immobilised thereon, wherein said functional groups are predominantly located on the outer surface of the support.

In a further preferred aspect, the present invention provides selenium removal apparatus for removing one or more selenium species from a fluid, the apparatus comprising a bed of adsorbent and means for contacting the fluid with the bed of adsorbent, wherein the adsorbent comprises a support having functional groups capable of adsorbing selenium species immobilised thereon, wherein said functional groups are predominantly located on the outer surface of the support.

### BRIEF DESCRIPTION OF THE DRAWINGS

FIGS. 1 and 2 show adsorption of selenite from aqueous solution as a function of contact time as determined in Example 1A.

FIGS. 3 and 4 show adsorption of selenate from aqueous solution as a function of contact time as determined in Example 1B.

FIGS. 5 and 6 show adsorption of selenocyanate from aqueous solution as a function of contact time as determined in Example 1C.

FIG. 7 shows results of an adsorption study using a coated silica-based adsorbent as determined in Example 2.

FIG. 8 shows a breakthrough curve for selenocyanate solution with sulphate for three different adsorbents as determined in Example 3.

FIG. 9 shows a breakthrough curve for selenate solution for three different adsorbents as determined in Example 4.

FIG. 10 shows a breakthrough curve for solutions of three selenium species using the S-103 adsorbent as determined in Example 5.

FIGS. 11 and 12 show breakthrough curves for solutions of selenium species in the presence of sulphur species, using the S-103 adsorbent as determined in Example 6.

FIGS. 13 and 14 show the effect of using mixed adsorbents as determined in Example 7.

FIG. 15 shows adsorption behaviour at different pHs, as determined in Example 8.

FIGS. 16 and 17 show adsorption behaviour at different pHs, as determined in Example 9.

### DETAILED DESCRIPTION

Preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

The nature of the solid support material of the adsorbent is not particularly limited. Typically, the support material is in the form of particles such as powder, granules or fibres.

Where the support is a fibre, typically the fibre diameter (e.g. number average fibre diameter) is about 0.05 mm. For example, the fibre diameter may be in the range from 0.01 mm to 0.1 mm, more preferably 0.03 mm to 0.07 mm. The fibre length is not particularly limited. Short fibres having a length (e.g. number average length) of about 0.3 mm may be particularly suitable, e.g. in the range from 0.1-1 mm. Longer fibres, e.g. up to about 50 mm may also be suitable. Fibres may be formed into pads or papers using techniques known to the skilled person such as wet laying.

Where the support is a granule or powder, typical number average particle diameters are in the range from 0.1 mm to 0.5 mm, but this is not particularly limited. For example, diameters ranging from 0.01 mm or 0.05 mm to 1 mm are suitable, although smaller and larger particles are also appropriate.

It may be preferred that the support is substantially non-porous. For example, the support may be formed of polymer material, which may be substantially non-porous. Suitable polymer materials include organic polymer materials. Particularly preferred are hydrocarbon polymers such as polyolefin materials. Particularly suitable polyolefins are polyethylene, polypropylene, polybutylene etc. Other hydrocarbon polymers such as polystyrene are also suitable.

However, it is not essential that the support material is non-porous. For example, the support material could be a porous material with a coating (e.g. a polymer coating) provided on the outer surface thereof. The polymer coating may itself comprise functional groups capable of adsorbing selenium, in which case further modification of the surface may be unnecessary. Alternatively, the surface of the polymer coating may be modified to attach functional groups capable of adsorbing selenium, and/or to modify the functional groups of the polymer to enhance selenium adsorption. A particularly suitable polymer coating is a nitrogen-containing polymer coating, such as a polyamide or a polyimine. Particularly suitable is polyethyleneimine (PEI).

It will be understood that in some cases it may be preferable to activate the surface of the support to facilitate immobilisation of the functional groups. Suitable surface activation techniques will be known to those skilled in the art, including for example plasma treatment, corona discharge and flame treatment.

Suitable adsorbents include Smopex® adsorbents available from Johnson Matthey PLC, and WP ion exchange resins available from Purity Systems Incorporated.

As discussed above, in the adsorbents of the present invention the functional groups of the adsorbent are preferably predominantly located on the outer surface of the support. Where the support material is in the form of particles, the functional groups of the adsorbent are typically predominantly located on the outer surface of the support particles. For example, at least 70%, at least 80%, at least 90% or at least 95% by number of the functional groups may be located on the outer surface of the support particles. The skilled person is readily able to determine the location of the functional groups using standard techniques, such as electron microscopy.

The nature of the functional groups of the adsorbent is not particularly limited in the present invention. The functional groups are capable of adsorbing one or more selenium species. Particularly preferred are functional groups comprising nitrogen atoms and/or comprising sulphur atoms.

In some embodiments it is preferred that the functional group is a nitrogen-containing functional group. For example, the functional group may contain one or more basic nitrogen moieties (in the free base form or the acid addition salt thereof). Particularly preferred are functional groups comprising an amine moiety, particularly a tertiary or quaternary amine moiety, most preferably a quaternary amine moiety. For example, the functional group may comprise an amine moiety of the formula —NR₃ where each R group is independently selected from hydrogen, optionally substituted C₁₋₁₀ alkyl and optionally substituted C₁₋₁₀ aralkyl, preferably hydrogen or C₁₋₁₀ alkyl, more preferably hydrogen or C₁₋₅ alkyl. None, one or two of the R groups may be hydrogen, preferably none or one, most preferably none. For example, each R group may be independently selected from methyl and ethyl. A particularly preferred functional group includes a trimethylamine moiety. It will be understood that two R groups may together form a cyclic substituent on the nitrogen atom. It will be understood that the amine moiety may form part of a polymer such as polyalkylenimine, such as polyethyleneimine or polypropylene imine. It will be understood that the nitrogen atoms of such polymers are optionally substituted with one or two R groups, wherein each R group is independently selected from optionally substituted C₁₋₁₀ alkyl and optionally substituted C₁₋₁₀ aralkyl, preferably C₁₋₁₀ alkyl, more preferably C₁₋₅ alkyl.

The functional group may comprise a heteroaryl moiety comprising a nitrogen atom in the aromatic ring, such as a pyridine moiety. The moiety may be in its free base form or in the form of an acid addition salt. The heteroaryl moiety may be N-substituted. The substituent on the N atom may be, for example, selected from optionally substituted C₁₋₁₀ alkyl and optionally substituted C₁₋₁₀ aralkyl. Particularly suitable substituents include C₁₋₅ alkyl and benzyl. Particularly suitable moieties include pyridine and benzyl pyridinium (e.g. benzyl pyridinium chloride).

Where the nitrogen containing moiety is in the form of its acid addition salt, the acid addition salt may be the hydrochloride salt.

Preferred nitrogen-containing functional groups include:

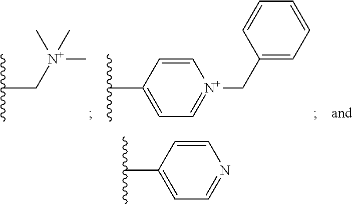

in its free base or acid addition salt form.

Where the functional group is charged, a suitable counter ion is provided. The nature of the counter ion is not particularly limited, and the skilled person will be aware of suitable counter ions. For example, the counter ion may be a halide ion, such as Cl⁻. Accordingly, suitable nitrogen containing functional groups include:

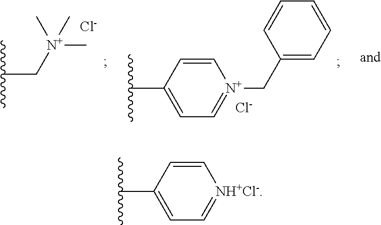

In some embodiments, it is preferred that the functional group is a sulphur-containing functional group. For example, the functional group may include a thiol moiety or a thioester moiety, preferably a thiol moiety. The functional group may comprise the moiety R¹O—CR²H—CH₂—SH. In one embodiment, R¹ is a linker attaching the moiety to the support and R² is C₁₋₅ alkyl or H, preferably H. In another embodiment, R² is a linker attaching the moiety to the support and R¹ is C₁₋₅ alkyl or H, preferably H.

Preferred sulphur-containing functional groups include:

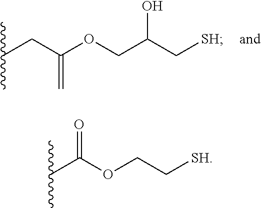

In some embodiments, at least two different functional groups capable of adsorbing selenium species are provided. This could be achieved, for example, by providing a mixture of two or more different adsorbents, each adsorbent having different functional groups immobilised thereon.

Where at least two different functional groups are provided, preferably at least one nitrogen-containing functional group is provided and at least one sulphur-containing functional group is provided. For example, a functional group comprising an amine moiety may be provided in combination with a sulphur-containing functional group such as a functional group comprising a thiol moiety. A functional group comprising a heteroaryl moiety comprising a nitrogen atom may be provided in combination with a sulphur-containing functional group such as a functional group comprising a thiol moiety.

In an alternative embodiment, the two different functional groups may be two nitrogen-containing functional groups having different structure. For example, a functional group comprising an amine moiety may be provided in combination with a functional group comprising a heteroaryl moiety comprising a nitrogen atom.

The functional groups may be immobilised directly on the surface of the support. However, in some embodiments, it is preferred that the functional groups form part of a polymer chain, the polymer being immobilised on the surface of the support. Each polymer chain may include a plurality of functional groups. Each polymer chain may have a single point of attachment to the support, or there may be multiple points of attachment. In this way, multiple functional groups may be provided to the support, e.g. via a single point of attachment. For example, the ratio of functional groups to points of attachment to the support may be 2 or more, for example 3 or more, 5 or more or 10 or more. The present inventors consider that this can help to enhance selenium adsorption. The functional groups may be provided in this way for example by growing polymer chains on the surface of the support.

In the present invention, the selenium species adsorbed is preferably one or more selected from selenate, selenite and selenide (e.g. selenocyanate). In some embodiments, each of selenate, selenite and selenide (e.g. selenocyanate) is adsorbed. Alternatively, any two of selenate, selenite and selenide (e.g. selenocyanate) may be adsorbed. It will be understood that the fluid (e.g. water) to be treated may include one, two or each of these species.

Where selenite is to be adsorbed, preferably one or both of the following functional groups are provided:

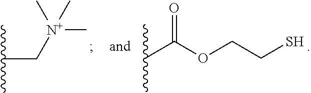

The charged nitrogen-containing functional group typically has a suitable counter ion, such as a halide ion, such as a Cl⁻ ion.

Where selenate is to be adsorbed, preferably a nitrogen-containing functional group (e.g. as defined above) is employed. For example, one or more of the following functional groups may be provided:

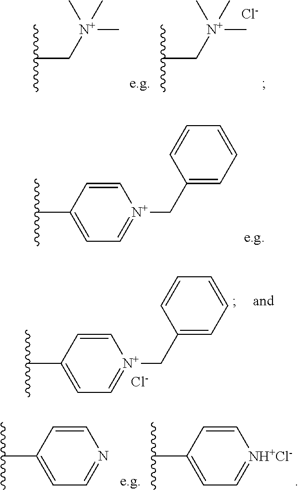

Where selenide (e.g. selenocyanate) is to be adsorbed, preferably a nitrogen-containing functional group is employed. Preferably a functional group comprising an amine moiety as defined above is provided, and/or a functional group comprising an N-substituted heteroaryl as defined above is provided. For example, one or more of the following functional groups may be provided:

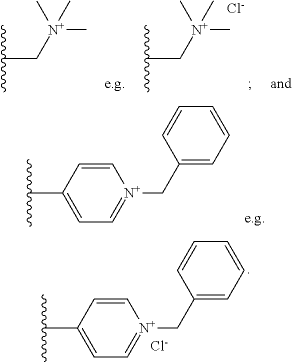

Alternatively, a sulphur-containing functional group (as defined above) may be employed where selenide (e.g. selenocyanate) is to be adsorbed. For example, the following functional group may be preferred:

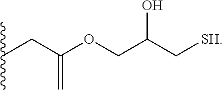 [SMILES: *CC(=C)OCC(O)CS]

The present invention provides use of adsorbents for adsorbing selenium. The feed from which selenium species are adsorbed is not particularly limited. Preferably, the feed is a fluid, e.g. a liquid. More preferably, the feed is an aqueous liquid.

Preferably, the adsorbents of the invention are used for treating water. For example, the selenium may be removed from waste water, e.g. waste water from an industrial process. The present inventors consider that the present invention is particularly applicable to removal of selenium species from waste water from refineries (e.g. petroleum refineries), coal and oil fired power plants, ground water and mine tailings. The uses and methods of the present invention include methods of purifying waste water.

In some embodiments, the feed to be treated includes sulphur species, for example one or more of sulphite, sulphate and sulphide.

In some embodiments, the feed to be treated includes organic material. The adsorbents of the present invention are particularly advantageous where the feed to be treated includes organic compounds, since the functional groups involved in selenium adsorption are located at the outer surface of the adsorbent. In contrast, where functional groups for adsorption are provided throughout the pore volume, the presence of organics can lead to clogging and seriously reduce the performance of the adsorbents.

In the methods of the present invention, the content of selenium species in the feed following treatment is preferably reduced to below 500 ppb, more preferably below 400 ppb, below 300 ppb or below 200 ppb. Most preferably, the content of selenium species in the feed following treatment is reduced to below 100 ppb or below 50 ppb. It may contain 0 ppb, at least 1 ppb, at least 2 ppb or at least 5 ppb selenium species. The feed to be treated may contain at least 1000 ppb selenium species, or at least 500 ppb selenium species. The upper limit of the selenium content of the feed to be treated is not particularly limited, but may typically be 5000 ppm or less, 2500 ppm or less, or 1000 ppm or less.

Preferably, the feed to be treated has a pH in the range from 4 to 14, more preferably from 6 to 14, or from 7 to 14. More preferably, the feed to be treated has a pH in the range from 6 to 12, from 6 to 9, from 7 to 12 or from 7 to 9. In other preferable embodiments, the feed to be treated has a pH in the range from 6 to 8 or from 7 to 8.

Preferably, the adsorbent is provided as a bed of adsorbent. For example, it may be provided as a filter bed, fixed bed, a packed column, fluidised or ebuliated bed, or a radial flow fixed bed. The adsorbent may be incorporated into a carrier such as paper or felt and used in either a reactor or filter element. The adsorbent may also be used within a stirred tank reactor or as a suspension within a tank or reactor.

### EXAMPLES

### Example 1

### Adsorption of Selenium Species from Aqueous Solution Using Functionalised Polymer Fibres

### Example 1A

### Selenite SeO₃²⁻

Smopex® fibres were tested for their ability to adsorb selenite from aqueous solution. Smopex® fibres are thin fibres of organic polymer, which have functional groups grafted onto their outside surface. The following Smopex® fibres were tested, and the grafted functional group for each is illustrated in Table 1 below. Each of the Smopex® fibres below are commercially available from Johnson Matthey PLC—Scavenging Technologies.

TABLE 1

| Smopex Fibre | Functional Group |
|---|---|
| S-103 | 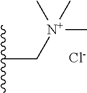 |
| S-269 | 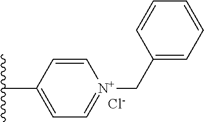 [SMILES: *c1cc[n+](Cc2ccccc2)cc1 ; [Cl-]] |
| S-112 | 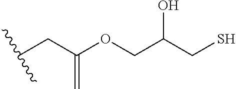 [SMILES: *CC(=C)OCC(O)CS] |
| S-234 | 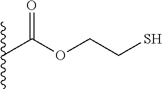 [SMILES: *C(=O)OCCS] |
| S-105 | 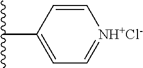 |

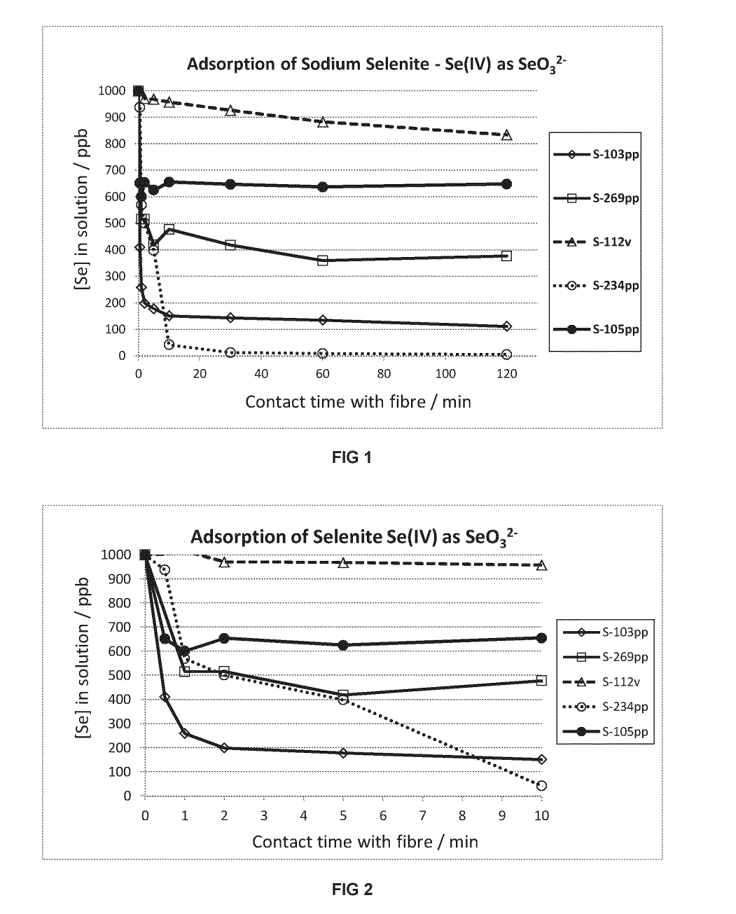

Each fibre type was tested for selenite adsorption from aqueous solution. 1000 ppb aqueous selenite solution was contacted with 1 wt % of fibre in a stirred tank reactor. The concentration of selenite remaining in the solution was determined as a function of contact time with the fibre. The results are shown in FIGS. 1 and 2. FIG. 2 shows an expanded plot of the first ten minutes of adsorption.

The results show that S-234 and S-103 are particularly good at adsorbing selenite, with S-269 and S-105 showing reasonable adsorption. S-112 does not show particularly high levels of adsorption.

### Example 1B

### Selenate SeO₄²⁻

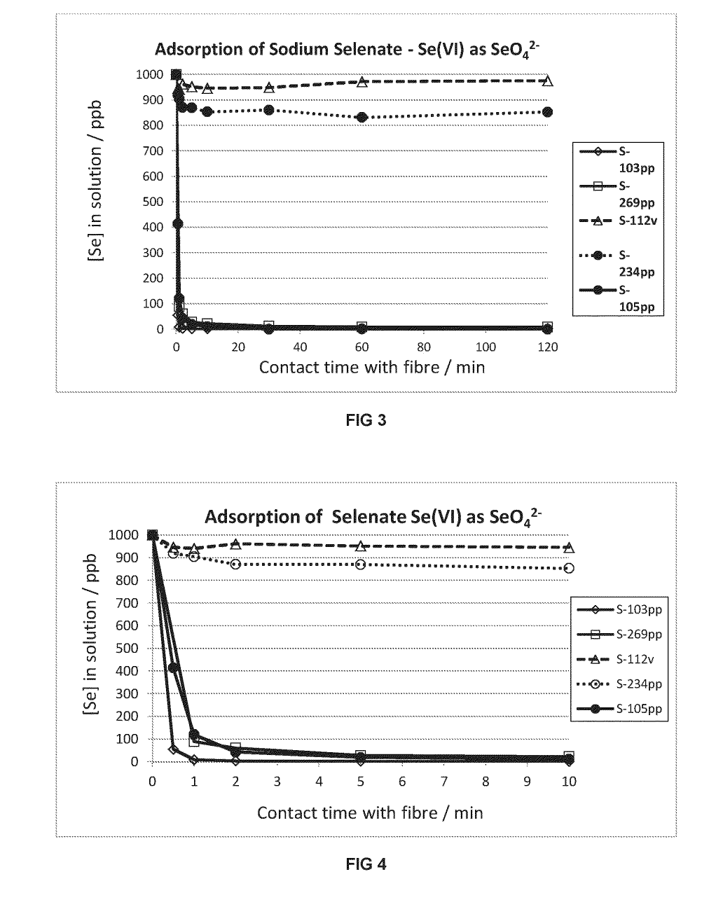

Adsorption of selenate was investigated. 1000 ppb aqueous selenate solution was contacted with 1 wt % of fibre in a stirred tank reactor. The concentration of selenate remaining in the solution was determined as a function of contact time with the fibre. The results are shown in FIGS. 3 and 4. FIG. 4 shows an expanded plot of the first ten minutes of adsorption.

The results show that S-103, S-269 and S-105 are extremely good at selenate adsorption, and rapidly decrease concentration to near zero levels. S-103 and S-234 do not show particularly high levels of adsorption.

### Example 1C

### Selenocyanate SeCN⁻

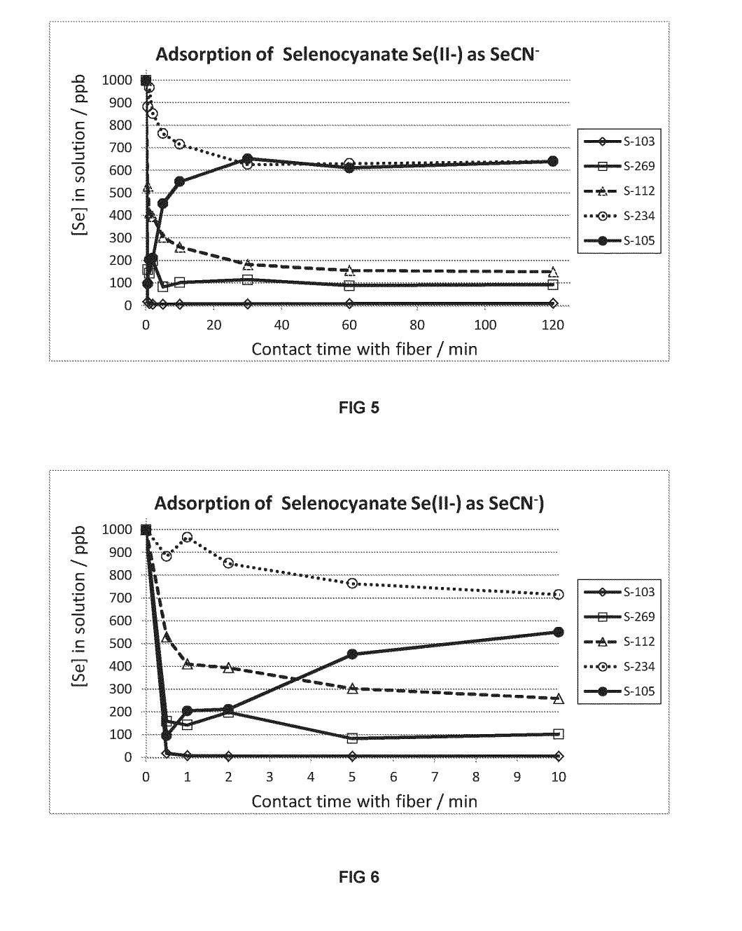

Adsorption of selenocyanate was investigated. 1000 ppb aqueous selenocyanate solution was contacted with 1 wt % of fibre in a stirred tank reactor. The concentration of selenocyanate remaining in the solution was determined as a function of contact time with the fibre. The results are shown in FIGS. 5 and 6. FIG. 6 shows an expanded plot of the first ten minutes of adsorption.

The results show that S-103, S-269 and S-112 are particularly good at adsorbing selenocyanate. S-105 and S-234 show moderate levels of adsorption.

Table 2 below summarises the results from the adsorption studies on the three selenium species tested.

TABLE 2

| | | Selenate | Selenocyanate |
|---|---|---|---|
| Fibre | Selenite Adsorption | Adsorption | Adsorption |
| S-103 | Excellent | Excellent | Excellent |
| S-105 | Moderate | Excellent | Moderate |
| S-269 | Moderate | Excellent | Excellent |
| S-234 | Excellent | Low | Moderate |
| S-112 | Low | Low | Excellent |

Accordingly, Example 1 demonstrates that excellent adsorption of some or all selenium species can be achieved by each of the Smopex® fibres tested. For selenium removal, the choice of fibre(s) is determined by the selenium speciation in the water to be treated.

### Example 2

### Adsorption of Selenium Species from Aqueous Solution Using Polyethyleneimine-Coated Silica Beads

Resin available from Purity Systems Incorporated were tested for their ability to adsorb selenium species from solution. The resin used is WP-1 resin available from Polymer Systems Incorporated (also known as WPGM resin).

The resin was tested for its ability to adsorb the three selenium species tested above in Example 1. 1000 ppb aqueous solutions of each were tested with 1 wt % WP-1 resin. The concentration of selenate remaining in the solution was determined as a function of contact time with the resin.

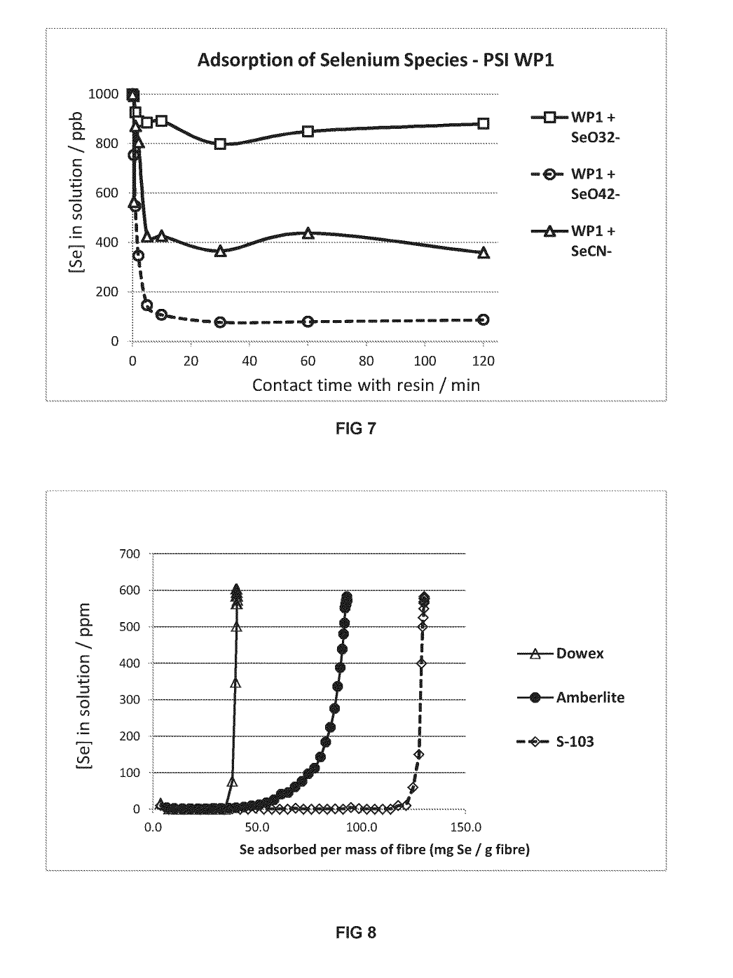

The results are shown in FIG. 7. The results show that selenate is very well adsorbed, selenocyanate is moderately adsorbed. WP-1 does not show particularly high levels of selenite adsorption.

### Example 3

### Adsorption of Selenocyanate in the Presence of Sulphate

Breakthrough studies were carried out to determine Se adsorption per mass of adsorbent for S-103 and two commercially available materials<Amberlite IRA-900 and Dowex 1×2 100-200 mesh.

The Amberlite product is a high porosity styrenic polymer resin, having strong base functionality. The Amberlite functional group is:

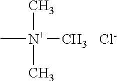

The Dowex product is a styrene-divinylbenzene gel with a trimethylbenzylammonium functional group.

Both products are highly porous and have their respective functional groups present throughout their pore volume.

FIG. 8 shows a breakthrough curve for S-103, the Amberlite product and the Dowex product. An aqueous solution of selenocyanate (600 ppm) with sulphate (6000 ppm) was passed over a column of each of the adsorbent materials, and the effluent analysed. The results show that S-103 has increased capacity for selenocyanate compared with two other strong base adsorbents.

The results also show that S-103 has very good adsorption kinetics, demonstrated by the shape of the breakthrough curve at the point of breakthrough. In contrast, the Amberlite resin shows a much slower breakthrough, indicating that diffusion effects are limiting the adsorption. Accordingly, despite a maximum capacity of approximately 80 mg Se/g absorbent, the Amberlite is useful for selenium adsorption really only to a maximum capacity of about 50 mg Se/g absorbent as breakthrough is seen after this point.

Without wishing to be bound by theory, the present inventors believe that the improved adsorption behaviour of the S-103 material compared with other adsorbents with similar functionality arises as a result of the structure and morphology of the Smopex® materials. In particular, in the Smopex® materials the functional groups are located on the outer surface of the fibres. In contrast, the Dowex and Amberlite products have their functional groups present throughout their pore volume.

### Example 4

### Adsorption of Selenate

A similar breakthrough study to that described in Example 3 was carried out using 1000 ppm selenate in aqueous solution. The results are shown in FIG. 9.

The results show that S-103 is superior to both the Amberlite product (IRA-900) and the Dowex product (1×2 100-200 mesh) for adsorption of selenate. Again, a high adsorption capacity is attained, and sharp breakthrough compared with the alternative adsorbents.

### Example 5

### Breakthrough of Selenium Species with S-103

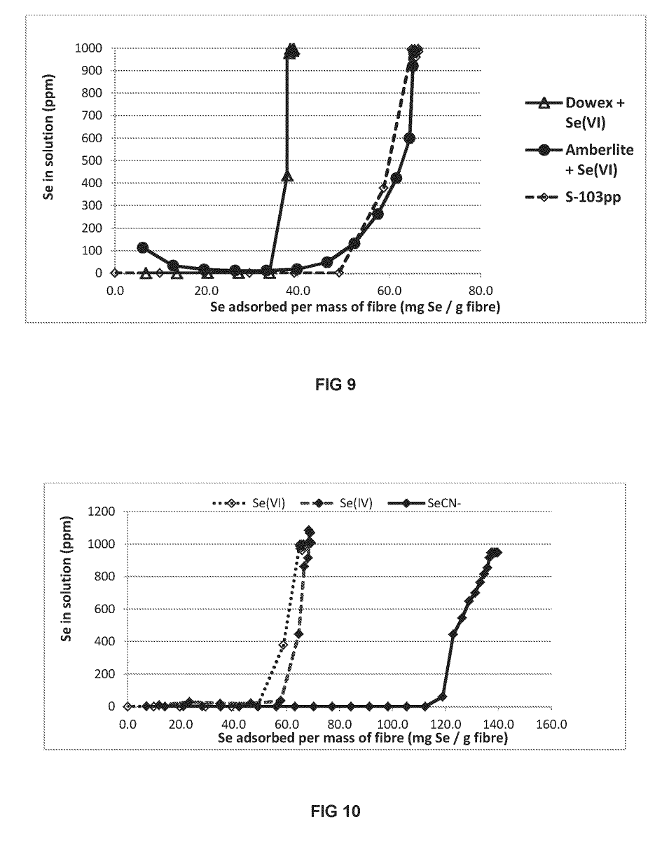

FIG. 10 shows the breakthrough of the three selenium species when a solution of each was passed over a column of S-103. The concentration of each solution was 1000 ppm. It can be seen that a sharp breakthrough curve is achieved for each selenium species, illustrating that the advantageous kinetics of adsorption are observed for all selenium species.

### Example 6

### Breakthrough of Selenium Species with S-103 in the Presence of Sulphur Species

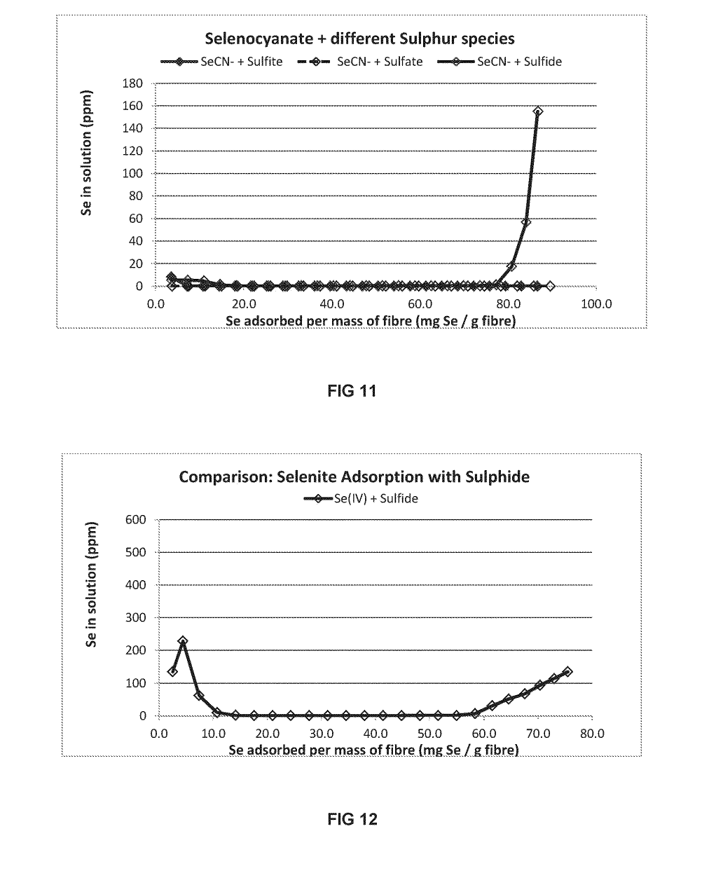

FIG. 11 shows breakthrough curves for three solutions passed over an S-103 column. The concentration of each solution was 600 ppm. The results show that sulphite and sulphate do not interfere with selenocyanate adsorption. A reduction in maximum adsorption is observed in the presence of sulphide, but this is still at very useful levels and shows the desirable sharp breakthrough curve shape.

FIG. 12 shows that good selenite adsorption is achieved in the presence of sulphide. A solution of 600 ppm selenite and 600 ppm sulphide was passed over an S-103 column. Breakthrough is at about 60 mg Se/g absorbent, which is similar to that observed in the absence of sulphur species (see Example 5). The breakthrough kinetics are altered slightly, indicating that there is some interaction between the selenite and sulphide.

### Example 7

### Adsorption Using Mixed Adsorbents

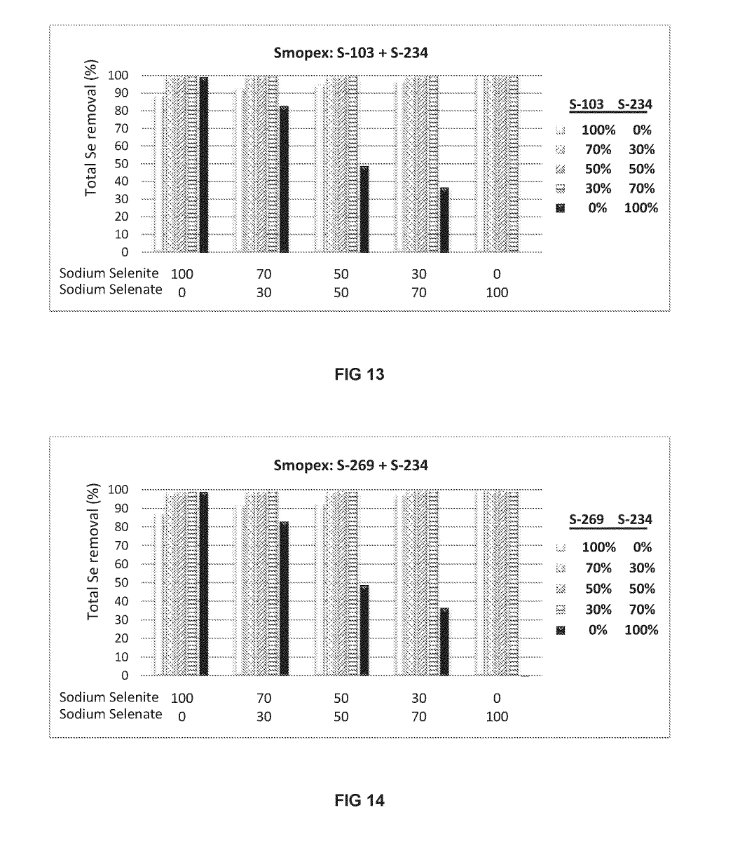

The effect of using a mixture of adsorbents on adsorption of selenium species was studied. The results are shown in FIGS. 13 and 14. The results show improved adsorption of both selenate and selenite in the presence of Smopex® adsorbents having two different functional groups. The results illustrated in FIGS. 13 and 14 also demonstrate that selenium can be effectively removed from solutions containing a mixture of selenium species.

### Example 8

### Adsorption at Different pHs

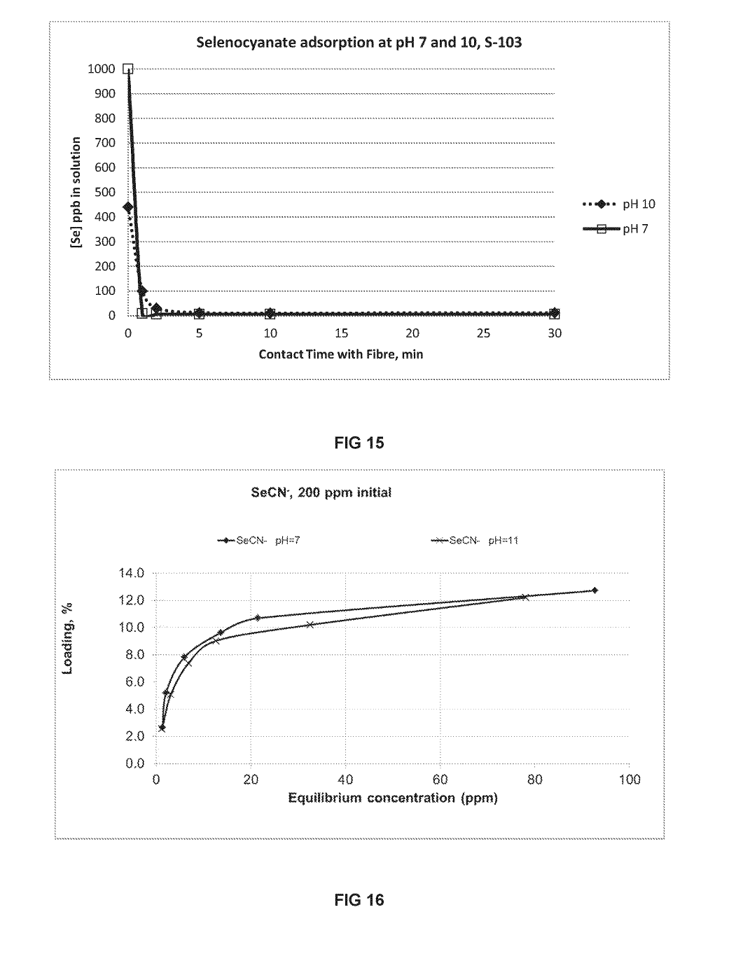

FIG. 15 shows that similar adsorption behaviour is observed for a model solution of 1000 ppb selenocyanate solution at pH7, and a real waste water feed sample containing selenite and selenocyanate at pH10-12, indicating that the adsorbents of the present invention can be used at a range of pHs.

### Example 9

### Adsorption at Different pHs

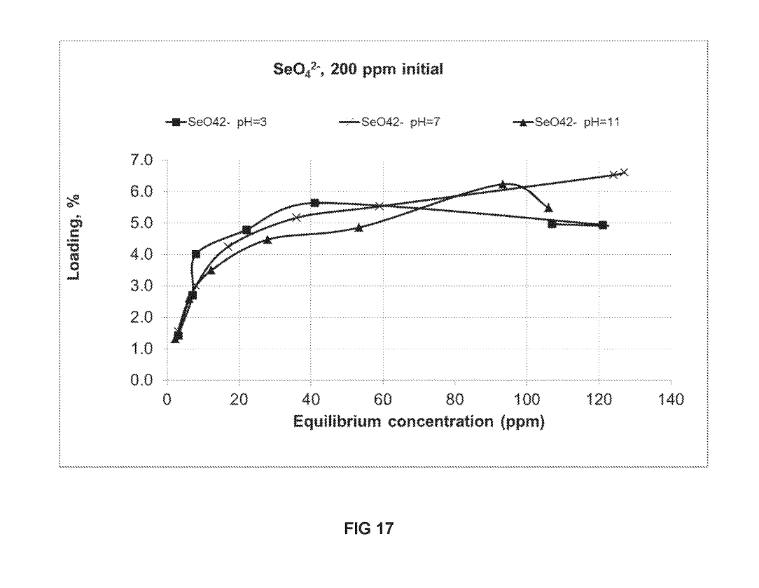

FIGS. 16 and 17 show the results of further experiments to probe adsorption of selenide and selenate species at different pHs. Multiple 200 ppm solutions of SeCN⁻ or SeO₄²⁻ were prepared, to which were added varying quantities of S-103 to provide the % loadings indicated in FIGS. 16 and 17.

The mixtures were stirred for an adequate time to achieve full equilibrium and the solution collected. The results show that adsorption of SeCN⁻ is not significantly affected by pH at least in the range pH7 to pH11 (SeCN⁻ is typically unstable at acid pH). Adsorption of SeO₄²⁻ is not significantly affected by pH at least in the range pH3 to pH11.

### CONCLUSIONS

The Examples described herein demonstrate that a range of different a range of different adsorbents of the present invention, having a range of different functional groups provided on their outer surface, show excellent adsorption of selenium. A combination of different functional groups provides particularly good adsorption. The Examples also demonstrate that the adsorbents of the present invention maintain good adsorption even in the presence of sulphur. Furthermore, the Examples demonstrate that even when very similar functional groups are employed, a marked improvement in adsorption and adsorption kinetics is observed where the adsorbing functional groups are located at the outer surface of the adsorbent rather than being distributed throughout the pore volume of the adsorbent.

### REFERENCES

1. Lenz M. (2008) “Biological selenium removal from wastewaters” Ph.D Thesis, Wageningen University, Wageningen, The Netherlands
2. Parida K. M., Gorai B., Das N. N., Rao S. B. (1997) “Studies on Ferric Oxide Hydroxides. III. Adsorption of Selenite on Different forms of Iron Oxyhydrides” J. Colloid Interface Sci, 185 (2) p. 355.
3. You Y, Vance G. F., Zhao H. (2001) “Selenium adsorption on Mg—Al and Zn—Al layered double hydroxides” Volume 20, Appl. Clay Sci 20 p. 13.
4. Jin S., Fallgren P. Western Research Institute (2006), “Applications of layered double hydroxides in removing oxyanions from oil refining and coal mining wastewater” report for U.S. Department of Energy
5. Das J., Das D., Dash G. P., Parida K. M. (2002) “Studies on Mg/Fe Hydrotalcite-Like-Compound (HTIc) I. Removal of Inorganic Selenite (SeO2-3) from Aqueous Medium” J Colloid Interface Sci 251 p. 26
6. O'Neill G. A., Novak J. W., Martin E. S. (1990) “Method for removing arsenic or selenium from an aqueous solution containing a substantial background of another contaminant” U.S. Pat. No. 4,935,146, June 1990.
7. WSPA, “Selenium Removal Technology Study—Final Report” (Western States Petroleum Association, Concord, Calif., July 1995)
8. A. Ramana, A. K. Sengupta; “Removing Selenium (IV) and Arsenic (V) Oxyanions with Tailored Chelating Polymers”; J. Env. Eng., ASCE, 118, (5), 755-75

1-16. (canceled)

17. An adsorbent for adsorption of one or more selenium species, wherein the adsorbent comprises a support having functional groups capable of adsorbing selenium species immobilized thereon, wherein at least two different functional groups capable of adsorbing selenium species are provided, and wherein:
(i) at least one nitrogen-containing functional group is provided and at least one sulphur-containing functional group is provided and/or
(ii) at least one functional group comprising an amine moiety is provided and at least one functional group comprising a heteroaryl moiety comprising a nitrogen atom in the aromatic ring is provided.

18. The adsorbent according to claim 17 wherein a functional group comprising an amine moiety is provided and a functional group comprising a thiol moiety is provided.

19. The adsorbent according to claim 17 wherein a functional group comprising a heteroaryl moiety comprising a nitrogen atom in the aromatic ring is provided and a functional group comprising a thiol moiety is provided.

20. The adsorbent according to claim 17 wherein said at least two different functional groups are selected from: 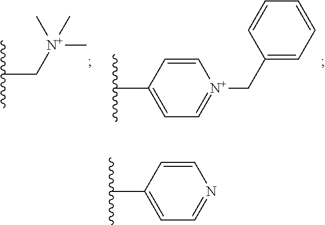
in its free base or acid addition salt form;

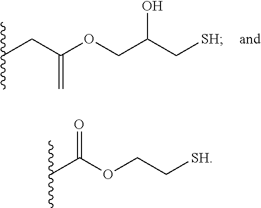

21. The adsorbent according to claim 17 wherein the functional groups capable of adsorbing selenium species are predominantly located on the outer surface of the support.

22. A method for the purification of water by the removal of one or more selenium species from the water, the method comprising contacting the water with an adsorbent, wherein the adsorbent comprises a support having functional groups capable of adsorbing selenium species immobilized thereon, wherein at least two different functional groups capable of adsorbing selenium species are provided, and wherein
(i) at least one nitrogen-containing functional group is provided and at least one sulphur-containing functional group is provided and/or
(ii) a functional group comprising an amine moiety is provided and a functional group comprising a heteroaryl moiety comprising a nitrogen atom in the aromatic ring is provided.

23. The method according to claim 22 wherein a functional group comprising an amine moiety is provided and a functional group comprising a thiol moiety is provided.

24. The method according to claim 22 wherein a functional group comprising a heteroaryl moiety comprising a nitrogen atom in the aromatic ring is provided and a functional group comprising a thiol moiety is provided.

25. The method according to claim 22 wherein said at least two different functional groups are selected from: 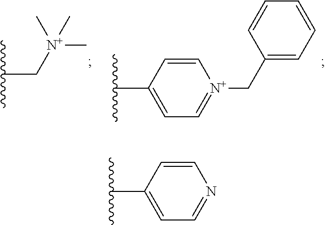
in its free base or acid addition salt form;

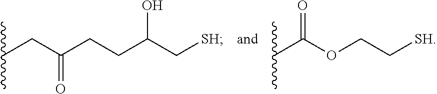 [SMILES: *CC(=O)CCC(O)CS ; *C(=O)OCCS]

26. The method according to claim 22 wherein the functional groups capable of adsorbing selenium species are predominantly located on the outer surface of the support.

27. Selenium removal apparatus for removing one or more selenium species from a fluid, the apparatus comprising a bed of adsorbent and means for contacting the fluid with the bed of adsorbent, wherein the adsorbent comprises a support having functional groups capable of adsorbing selenium species immobilized thereon, wherein at least two different functional groups capable of adsorbing selenium species are provided and wherein
(i) at least one nitrogen-containing functional group is provided and at least one sulphur-containing functional group is provided and/or
(ii) at least one functional group comprising an amine moiety is provided and at least one functional group comprising a heteroaryl moiety comprising a nitrogen atom in the aromatic ring is provided.

28. The selenium removal apparatus according to claim 27 wherein said at least two different functional groups are selected from: 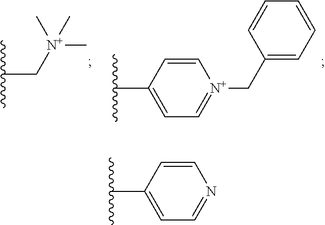
in its free base or acid addition salt form; [chemical structure]
